(19) United States
(12) Patent Application Publication
(10) Pub. No.: US 2004/0133926 A1
(43) Pub. Date: Jul. 8, 2004

(54) Additional information inserting apparatus and method

(75) Inventor: Kohji Numata, Tokyo (JP)

Correspondence Address: YOUNG & THOMPSON, 745 SOUTH 23RD STREET 2ND FLOOR, ARLINGTON, VA, 22202

(73) Assignee: NEC CORPORATION, TOKYO (JP)

(21) Appl. No.: 10/738,994

(22) Filed: Dec. 19, 2003

(30) Foreign Application Priority Data
Dec. 19, 2002 (JP) 2002-368372

(51) Int. Cl. H04N 7/16; H04N 7/08; H04N 7/52; H04N 5/90; H04N 5/85; H04N 5/781; H04N 7/06

(52) U.S. Cl. 725/135; 725/136; 348/461; 348/468; 386/95; 386/125

(57) ABSTRACT

An additional information inserting apparatus automatically generates additional information to be added to an audio video signal, to be recorded or-transmitted, on the basis of original additional information inserted in an original audio video signal. Then, the apparatus automatically generates additional information in the audio video signal, for recording.

### BACKGROUND OF THE INVENTION

The present invention relates to an additional information inserting apparatus for adding additional information such as data time information and subtitles to an audio video signal, for recording or transmission, and a method therefor. In particular, the present invention relates to an additional information inserting apparatus for adding additional information to an audio video signal, that is to be recorded on a recording medium such as a DVD (Digital Versatile Disc), or an audio video signal, which should be transmitted, in a form of a sub-picture, and a method therefor.

According to standards for a DVD, a sub-picture can be inserted in an image to be displayed on a screen. The sub-picture comprises content that is overlaid on a main picture. The sub-picture is used for displaying additional information; for example, time information, information menu, subtitles of movie software and so on. The sub-picture is arbitrary in its size and position, but occupies an entire effective region of the screen in its maximum size. In addition, a maximum number of sub-pictures is thirty-two per a title. A viewer can select one to be displayed out of the available sub-pictures. Naturally, the user can also choose not to display any sub-picture at all.

Incidentally, in recent years, DVD recorders are being more widely used, and are expected to ultimately replace VTRs (Video Tape Recorders) in the future.

A general home user, for example, can dub a moving picture, which is recorded on videotape, onto a DVD using a DVD recorder, or can record a television broadcast onto the DVD using the DVD recorder.

However, conventionally, there is no technique for automatically dubbing the date and time of photographing, which is recorded on videotape, or character broadcast data (e.g., subtitles of movie software), which is included in a television broadcast, onto the DVD with the DVD recorder. Note that, prior art literatures related to the present invention includes Japanese Patent Laid-Open No. 2000-032388. The invention described in the patent literature records date data, time data, and the like onto a DVD as a sub-picture. However, a user has to manually input the date data and time data to be recorded, using a keyboard unit. Therefore, although the general home user has the DVD recorder, he/she cannot use a sub-picture effectively. This is true for not only the case in which a moving picture is recorded in the DVD but also the case in which a moving picture is recorded onto a hard disk drive or is transmitted.

### SUMMARY OF THE INVENTION

It is an object of the present invention to provide an additional information inserting apparatus which makes it possible to automatically generate additional information to be added to an audio video signal, which should be recorded or transmitted, on the basis of original additional information inserted in an original audio video signal, and insert the automatically generated additional information in the audio video signal, which should be recorded or transmitted, and a method therefor.

According to one aspect of the present invention, an additional information inserting apparatus is provided which comprises: extraction means which extracts original additional information inserted in an original audio video signal to be a basis of a secondary audio video signal which should be recorded or transmitted; generation means which generates secondary additional information, which should be added to the secondary audio video signal, on the basis of the original additional information; and addition means which adds the secondary additional information to the secondary audio video signal.

According to another aspect of the present invention, a sub-picture inserting apparatus is provided which comprises: a demultiplexer which inputs a time division multiplexing signal of audio data, compressed video data, and sub-code data, which are reproduced by a digital video tape producer from a digital tape and demultiplexes the time division multiplex signal into the audio data, the compressed video data, and the sub-code data; an audio data compression unit which compresses the audio data according to a method specified in a DVD system and outputs compressed audio data; a video data expansion unit which expands the compressed video data in accordance with a DV system and outputs restored video data; a video data compression unit which compresses the restored video data according to a method specified in the DVD system and outputs re-compressed video data; a date and time data buffer which stores date and time data; a date and time data comparison unit which extracts date and time data in the sub-code data, compares the extracted date and time data with date and time data stored in the date and time data buffer and updates contents of the date and time data buffer to new date and time data; a character code/bitmap conversion table which stores a bitmap of images of characters corresponding to respective character codes; a synthesized bitmap data generation unit which retrieves a bitmap of each character of the date and time data, which is inputted from the date and time data comparison unit, from the character code/bitmap conversion table, and synthesizes a bitmap of all the characters of the date and time data to generate synthesized bitmap data; a synthesized bitmap data buffer which stores the synthesized bitmap data; a sub-picture generation unit which compresses the synthesized bitmap data according to run-length coding and adds a predetermined header to the synthesized bitmap data to generate sub-picture data;

a multiplexer which multiplexes the compressed audio data, the re-compressed video data, and the sub-picture data in the time division manner and outputs a time division multiplexing signal; and a recording unit which records the time division multiplexing signal.

According to another aspect of the present invention, a sub-picture inserting apparatus is provided which comprises: an audio A/D converter which A/D-converts an analog audio signal outputted by an audio tuner of a television tuner and outputs audio data; an audio data compression unit which compresses the audio data according to a method specified in a DVD system and outputs compressed audio data; a compressed audio data buffer which delays the compressed audio data in variable time; a video A/D converter which converts an analog video signal outputted by the audio tuner of the television tuner and outputs video data; a video data compression unit which compresses the video data according to a method-specified in the DVD system and outputs compressed video data; a compressed video data buffer which delays the compressed video data in variable time; a subtitle bitmap extraction unit which extracts subtitle bitmap data, which is outputted by a character broadcast decoder of the television tuner, and outputs the subtitle bitmap data; an effective position cropping and four-color conversion unit which crops only an effective part from the subtitle bitmap data, converts the effective part into bitmap data of four or few colors to be used in a sub-picture and outputs the cropped and converted the subtitle bitmap data; a subtitle bitmap buffer which stores the subtitle bitmap data; a subtitle bitmap comparison unit which compares the subtitle bitmap data inputted the four-color conversion unit and the subtitle bit map stores in the subtitle bitmap buffer and proceeds according to a result of the comparison; a display continuing frame number counter which counts the number of frames in which display of each subtitle is continuing; a sub-picture generation unit which compresses the subtitle bitmap data according to run-length coding and adds a predetermined header to the subtitle bitmap to generate sub-picture data and output the sub-picture data; a multiplexer which multiplexes the compressed audio data, the compressed video data, and the sub-picture data in the time division manner and outputs a time division multiplexing signal; and a recording unit which records the time division multiplexing signal.

Other and further objects of this invention will become obvious upon an understanding of the illustrative embodiments about to be described or will be indicated in the appended claims, and various advantages not referred to herein will occur to one skilled in the art upon use of the invention in practice.

### BRIEF DESCRIPTION OF THE DRAWINGS

For a better understanding of the invention of the invention as well as other objects and features thereof, reference is made to the following detailed description to be read in conjunction with the accompanying drawings, wherein:

FIG. 1 is a block diagram showing a structure of a sub-picture inserting apparatus according to a first embodiment of the present invention;

FIG. 2 is a flowchart showing an operation of the sub-picture inserting apparatus according to the first embodiment of the present invention;

FIG. 3 is an example of a display screen of date and time information inserted by the sub-picture inserting apparatus according to the first embodiment of the present invention;

FIG. 4 is a block diagram showing a structure of a sub-picture inserting apparatus according to a second embodiment of the present invention;

FIG. 5 is a flowchart showing an operation of the sub-picture inserting apparatus according to the second embodiment of the present invention;

FIG. 6 is a block diagram showing a structure of a sub-picture inserting apparatus according to a third embodiment of the present invention;

FIG. 7 is a flowchart showing an operation of a part of the sub-picture inserting apparatus according to the third embodiment of the present invention;

FIG. 8 is a flowchart showing an operation of the other parts of the sub-picture inserting apparatus according to the third embodiment of the present invention;

FIG. 9 is a timing chart showing an example of an operation of the sub-picture inserting apparatus according to the third embodiment of the present invention;

FIG. 10 is a block diagram showing a structure of a sub-picture inserting apparatus according to a fourth embodiment of the present invention;

FIG. 11 is a flowchart showing an operation of a part of the sub-picture inserting apparatus according to the third embodiment of the present invention; and

FIG. 12 is a format diagram showing a structure of sub-picture data specified by DVD standards.

### DETAILED DESCRIPTION OF THE PREFERRED EMBODIMENTS

Embodiments of the present invention will be hereinafter described in detail with reference to the drawings. In the embodiments described below, a sub-picture inserting apparatus is illustrated as an example of an additional information inserting apparatus. However, the additional information inserting apparatus of the present invention is not limited to the sub-picture inserting apparatus.

A first embodiment of the present invention will be described below.

In the first embodiment, in dubbing audio data and video data, which is recorded on a DV tape, onto a DVD, photographing date and time recorded on the DV tape is also dubbed onto the DVD.

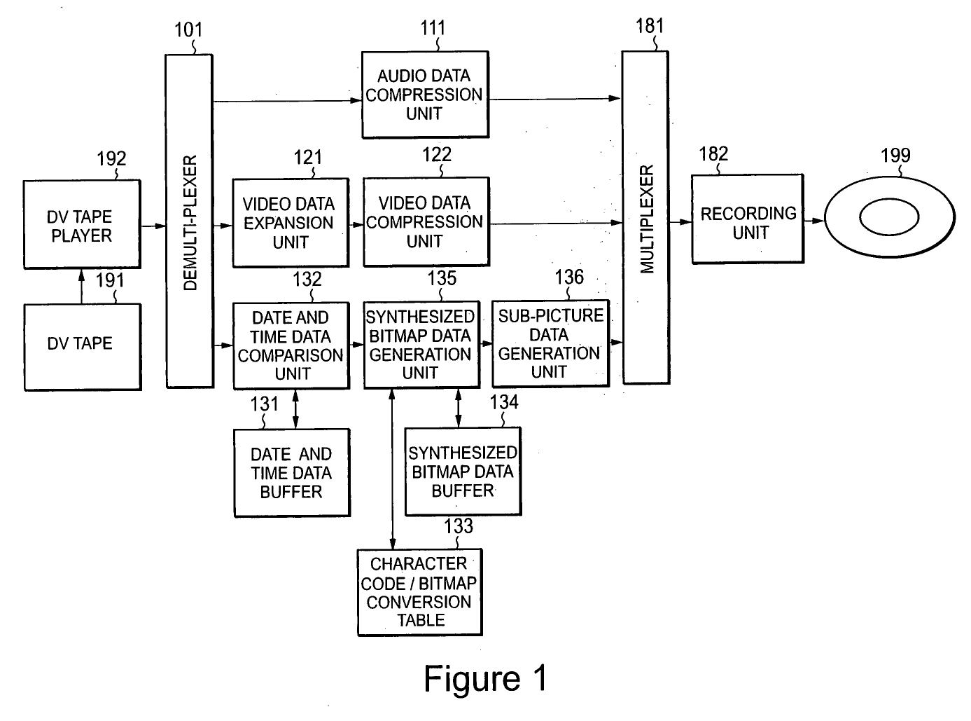

FIG. 1 is a block diagram showing a structure of a sub-picture inserting apparatus according to the first embodiment and the periphery thereof.

Referring to FIG. 1, the sub-picture inserting apparatus according to the first embodiment includes: a demultiplexer 101; an audio data compression unit 111; a video data expansion unit 121; a video data compression unit 122; a date and time data buffer 131; a date and time data comparison unit 132; a character code/bitmap conversion table 133; a synthesized bitmap data buffer 134; a synthesized bitmap data generation unit 135; a sub-picture generation unit 136; a multiplexer 181′, and a recording unit 182.

The demultiplexer 101 is connected to a DV tape player 192 by, for example, an IEEE 1394 serial interface. The demultiplexer inputs a time division multiplexed signal of audio data, compressed video data, and sub-code data, which are reproduced by the DV tape player 192 from the DV tape 191. Then, the demultiplexer 101 demultiplexes the time division multiplex signal into the audio data, the compressed video data, and the sub-code data, and supplies the audio data, the video data, and the sub-code data to the audio data compression unit 111, the video data expansion unit 121, and the date and time data comparison unit 132, respectively.

The audio data compression unit 111 compresses the audio data according to a method specified in a DVD system and supplies the compressed audio data to the multiplexer 181. Note that, since the audio data is not compressed in a DV format, it is unnecessary to place an audio data expansion unit between the demultiplexer 101 and the audio data compression unit 111. However, in the case in which compressed audio data of a format other than the DV format is inputted, it is necessary to place an audio data expansion unit between the demultiplexer 101 and the audio data compression unit 111. In addition, in the case in which uncompressed audio data can be recorded onto a DVD 199, uncompressed audio data outputted by the demultiplexer 101 may be directly supplied to the multiplexer 181.

The video data expansion unit 121 expands the compressed video data in accordance with the DV system and supplies restored video data to the video data compression unit 122.

The video data compression unit 122 compresses the restored video data according to a method specified in the DVD system and supplies re-compressed video data to the multiplexer 181. Note that, in the case in which uncompressed video data can be recorded onto the DVD 199, the restored video data (uncompressed video data) outputted by the video data expansion unit 121 may be directly supplied to the multiplexer 181.

The date and time data buffer 131 stores date and time data.

The date and time data comparison unit 132 extracts date and time data from the sub-code data and compares the extracted date and time data with date and time data stored in the date and time data buffer 131. If the date and time data in the sub-code has been updated, namely, if the date and time data in the sub-code is different from the date and time information stored in the date and time data buffer 131, the date and time data comparison unit 132 updates the contents of the date and time data buffer 131 to new date and time data. Then the date and time data comparison unit 132 supplies the new date and time data to the synthesized bitmap data generation unit 135.

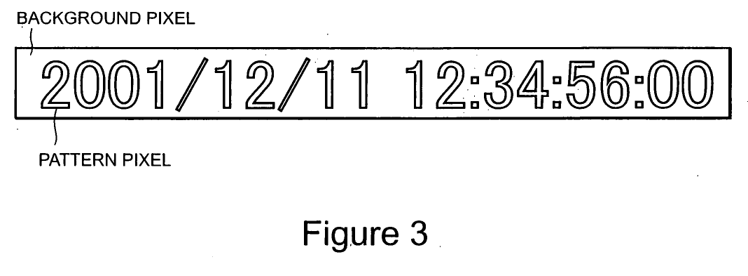

The character code/bitmap conversion table 133 stores bitmaps of images of characters corresponding to respective character codes. Note that each pixel of a sub-picture of the DVD system is a background pixel, a pattern pixel, a highlighted 1 pixel or a highlighted 2 pixel and is represented by two bits. However, for example, in order to represent date and time data, the background pixel and the pattern pixel are used as shown in FIG. 3.

The synthesized bitmap data buffer 134 stores synthesized bitmap data generated by the synthesized bitmap data generation unit 135.

The synthesized bitmap data generation unit 135 retrieves a bitmap of each character of the date and time data, which is inputted from the date and time data comparison unit 132, from the character code/bitmap conversion table 133, and synthesizes a bitmap of all the characters of the date and time data. Then, the synthesized bitmap data generation unit 135 supplies the synthesized bitmap data to the sub-picture data generation unit 136.

The sub-picture data generation unit 136 compresses the synthesized bitmap data according to run-length coding which is specified in the DVD system and adds a predetermined header to it to thereby generate sub-picture data, and supplies the sub-picture data to the multiplexer 181.

The multiplexer 181 multiplexes the compressed audio data, the re-compressed video data, and the sub-picture data in the time division manner and supplies a time division multiplexed signal, which is obtained as a result thereof, to the recording unit 182.

The recording unit 182 records the time division multiplexed signal, which is inputted from the multiplexer 181, onto the DVD 199.

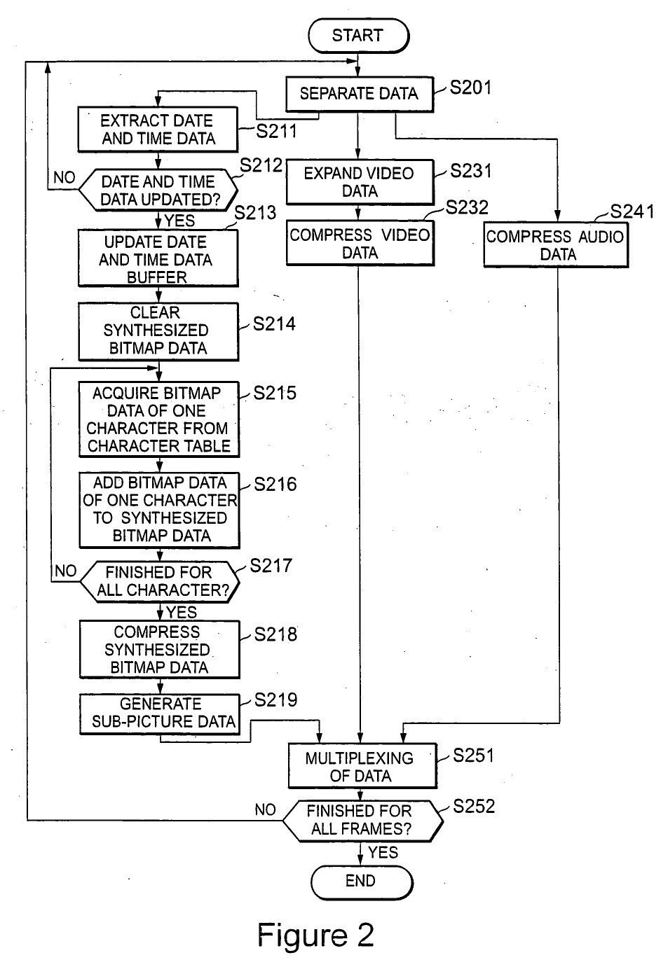

Next, operation of the sub-picture inserting apparatus according to the first embodiment will be described with reference to FIG. 2.

First, the demultiplexer 101 demultiplexes a time division multiplexed signal from the DV tape player 192 for each multiplexed unit time (step S201).

Next, processing of date and time data, processing of video data, and processing of audio data are performed in parallel with each other.

In the processing of date and time data, first, the date and time data comparison unit 132 extracts date and time data from the sub-code data (step S211) and determines whether or not the extracted date and time data has been updated with respect to the date and time data stored in the date and time data buffer 131 (step S212). If the date and time data has been updated, the date and time data comparison unit 132 updates contents of the date and time data buffer 131 to new date and time data (step S213) and supplies the new date and time data to the synthesized bitmap data generation unit 135.

The date and time data is updated approximately every 33 milliseconds if a frame rate of video data is 29.970 frames/second. However, update of the date and time data is performed using the unit of millisecond, second, or minute. The number of digits to be compared of the date and time data and the number of digits to be stored in the date and time data buffer 131 are changed depending upon which unit has been selected.

Whenever a new dates and time data is inputted from the date and time data comparison unit 132, the synthesized bitmap data generation unit 135 clears the synthesized bitmap data stored in the synthesized bitmap data buffer 134 (step S214), acquires bitmap data from the character code/bitmap conversion table 133 for each character of the newly inputted date and time data (step S215), adds the acquired bitmap data to the synthesized bitmap data, and repeats the operation of steps S215 and S216 (step S217) to supply completed synthesized bitmap data to the sub-picture generation unit 136.

The sub-picture data generation unit 136 compresses the inputted synthesized bitmap data (step S218) and adds a header to the synthesized bitmap data to thereby generate sub-picture data, and supplies the sub-picture data to the multiplexer (step S219).

In the processing of video data, first, the video data expansion unit 121 expands inputted compressed video data according to the method specified in DV system and supplies expanded video data to the video compression unit 122 (step S231). Next, the video data compression unit 122 compresses the expanded the video data according to the method specified in DVD system and supplies compressed video data to the multiplexer 181 (step S232).

In the processing of audio data, the audio data compression unit 111 compresses inputted audio data and supplies compressed audio data to the multiplexer 181 (step S241).

When the sub-picture data is inputted from the sub-picture data generation unit 136, the compressed video data is inputted from the video data compression unit 122, and the compressed audio data is inputted from the audio data compression unit 111, the multiplexer 181 multiplexes these data in the time division manner (step S251).

Next, the sub-picture inserting apparatus determines whether or not processing of all frames, which should be recorded onto the DVD 199, has been finished (step S252). If the processing has not been finished, the sub-picture inserting apparatus returns to step S201 and repeats the processing from step S201 to step S251. If the processing has been finished, the sub-picture inserting apparatus ends the processing.

A second embodiment of the present invention will be described below.

In the first embodiment, a sub-picture of only one type of date and time data is generated, and a unit for updating date and time data is one unit selected from the units of milliseconds, seconds, minutes, and the like.

In a second embodiment, given that the maximum number of sub-pictures is thirty-two, plural kinds of sub-pictures of date and time data (e.g., a sub-picture of date and time data which is updated by the unit of milliseconds, a sub-picture of date and time data which is updated by the unit of seconds, a sub-picture of date and time data which is updated by the unit of minutes, etc.) are generated from date and time data reproduced from the DV tape 191. All the plural sub-pictures are recorded onto the DVD 199. Then, a viewer selects from one of the available sub-pictures when the viewer plays the DVD 199.

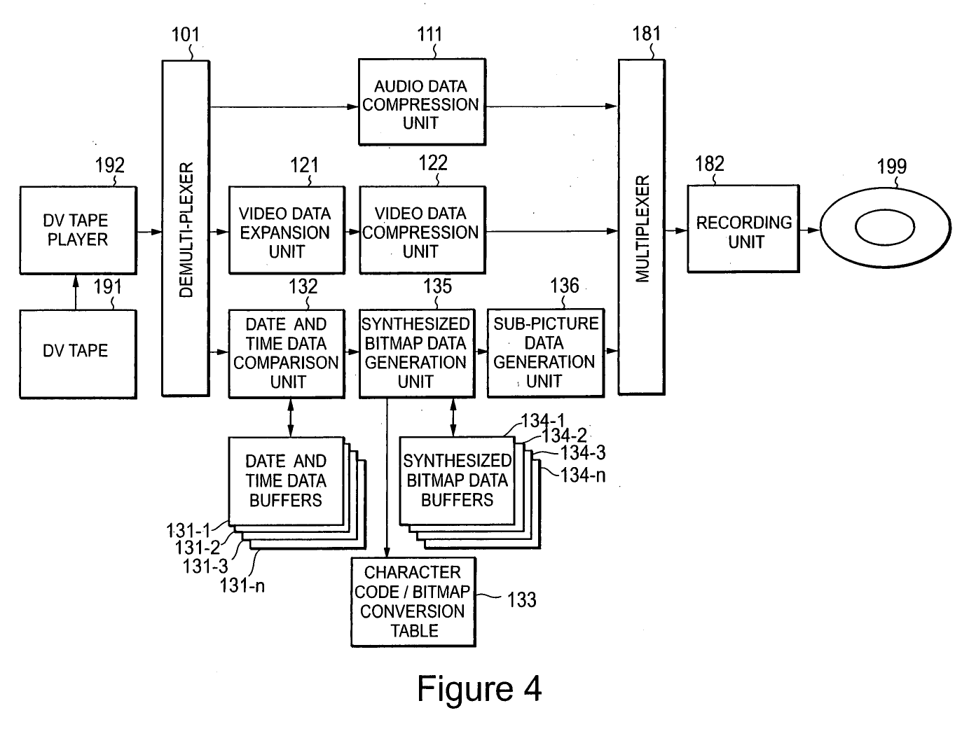

FIG. 4 is a block diagram showing a structure of a sub-picture inserting apparatus according to the second embodiment and the periphery thereof.

As it is evident when FIGS. 1 and 4 are compared, the sub-picture inserting apparatus according to the second embodiment is different from the sub-picture inserting apparatus according to the first embodiment in that the date and time buffer 131 is replaced with plural date and time data buffers 131-1, 131-2, 131-3, . . . , 131-n, and the synthesized bitmap data buffer 134 is changed to plural synthesized bitmap data buffers 134-1, 134-2, 134-3, . . . , 134-n.

Each of the date and time data buffers 131-1, 131-2, 131-3, . . . , 131-n stores date and time data for each sub-picture. For example, the date and time data buffer 131-1 stores date and time data by the unit of milliseconds, the date and time data buffer 131-2 stores date and time data by the unit of seconds, the date and time data buffer 131-3 stores date and time data by the unit of minutes, and the date and time data buffer 131-n stores date and time data by the unit of hours.

Each of the synthesized bitmap data buffers 134-1, 134-2, 134-3, . . . , 134-n stores synthesized bitmap data for each sub-picture. For example, the synthesized bitmap data buffer 134-1 stores synthesized bitmap data of date and time data by the unit of milliseconds, the synthesized bitmap data buffer 134-2 stores synthesized bitmap data of date and time data by the unit of seconds, the synthesized bitmap data buffer 134-3 stores synthesized bitmap data of date and time data by the unit of minutes, and the synthesized bitmap data buffer 134-n stores synthesized bitmap data of date and time data by the unit of hours.

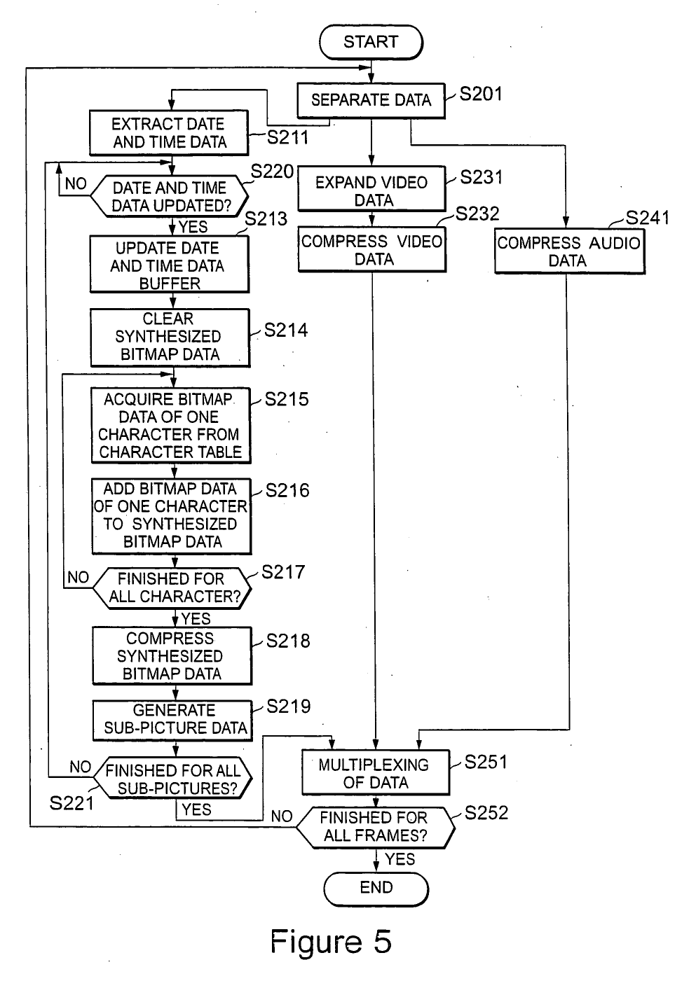

FIG. 5 is a flowchart showing an operation of the sub-picture inserting apparatus according to the second embodiment.

As is evident when FIGS. 2 and 5 are compared, the sub-picture inserting apparatus according to the second embodiment is different from the sub-picture inserting apparatus according to the first embodiment in terms of operation in that step S212 is replaced by step S220 and step S221 is inserted.

Since step S221 is inserted, steps S220 to S219 are repeated for all sub-pictures. Therefore, in step S251, all the sub-pictures are multiplexed with the re-compressed video data and the compressed audio data in the time division manner.

In step S220, it is determined whether or not date and time data has been updated on a different standard for each repetition. That is, for example, for a sub-picture of date and time data by the unit of milliseconds, it is determined whether or not the date and time data has been updated by the unit of milliseconds, and for a sub-picture of date and time data by the unit of seconds, it is determined whether or not the date and time data has been updated by the unit of seconds.

A third embodiment of the present invention will be described below.

In a third embodiment, in recording a television broadcast of a movie onto a DVD, subtitles are recorded as a sub-picture. In particular, the number of display continuing frames of subtitles is set as it is broadcasted.

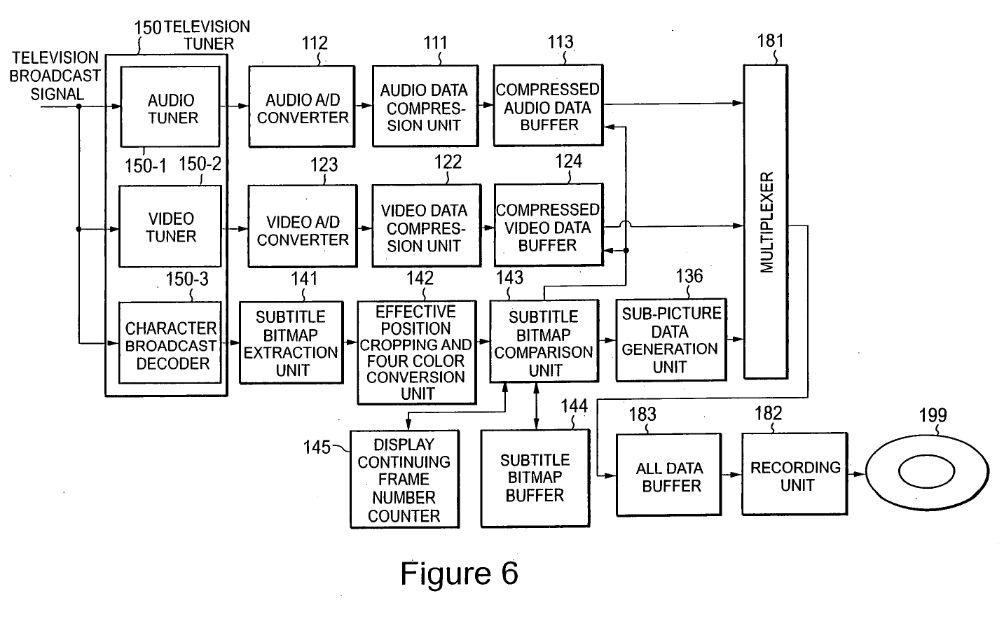

FIG. 6 is a block diagram showing a structure of a sub-picture inserting apparatus according to the third embodiment and the periphery thereof.

Referring to FIG. 6, the sub-picture inserting apparatus according to the third embodiment includes: an audio A/D converter 112; an audio data compression unit 111; a compressed audio data buffer 113; a video A/D converter 123; a video data compression unit 122; a compressed video data buffer 1-24; a subtitle bitmap extraction unit 141; an effective position cropping and four-color conversion unit 142; a subtitle bitmap comparison unit 143; a subtitle bitmap buffer 144; a display continuing frame number counter 145; a sub-picture generation unit 136; a multiplexer 181; an all data buffer 183; and a recording unit 182.

The audio A/D converter 112 A/D-converts an analog audio signal outputted by an audio tuner of a television tuner 150 to obtain audio data, and supplies the audio data to the audio data compression unit 111. The audio data compression unit 111 is the same as that in the first embodiment. The compressed audio data buffer 113 delays compressed audio data in variable time. Timing for reading out compressed audio data from the compressed audio data buffer 113 is controlled by the subtitle bitmap comparison unit 143. Compressed audio data and subtitle data can be synchronized by this control.

The video A/D converter 123 A/D converts an analog video signal outputted by the audio tuner of the television tuner 150 to obtain video data, and supplies the video data to the video compression unit 122. The video compression unit 122 is the same as that in the first embodiment. The compression video data buffer 124 delays compressed video data in variable time. Timing for reading out compressed video data from the compressed video data buffer 124 is controlled by the subtitle bitmap comparison unit 143. Compressed video data and subtitle data can be synchronized by this control.

The subtitle bitmap extraction unit 141 extracts a subtitle bitmap, which is outputted by a character broadcast decoder 150-3 of the television tuner 150, and supplies it to the effective position cropping and four-color conversion unit 142. The effective position cropping and four-color conversion unit 142 crops only an effective part from the inputted subtitle bitmap, converts the effective part into a bitmap of four or fewer colors to be used in a sub-picture, and supplies the cropped and converted subtitle bitmap to the subtitle bitmap comparison unit 143. The bitmap of four or fewer colors may be a bitmap consisting of only two colors of a background pixel bit and a pattern pixel bit.

The subtitle bitmap buffer 144 stores the subtitle bitmap temporarily.

The display continuing frame number counter 145 counts the number of frames in which display of each subtitle is continuing.

The subtitle bitmap comparison unit 143 performs processing described later such as effective position cropping and comparison of the subtitle bitmap inputted from the four-color conversion unit 142 and the subtitle bitmap stored in the subtitle bitmap buffer 144. In addition, the subtitle bitmap comparison unit 143 controls the display continuing frame number counter 145 as described later.

The sub-picture data generation unit 136 subjects the subtitle bitmap to run-length compression by a method specified in the DVD system and adds a predetermined header to the subtitle bitmap to thereby generate the sub-picture, and supplies the sub-picture to the multiplexer 181.

The multiplexer 181 is the same as that in the first embodiment.

The all data buffer 183 compensates for jitters of the compressed audio data, the compressed video buffer, and the sub-picture data generated in the compressed audio data buffer 113, the compressed video data buffer 124, the subtitle bitmap comparison unit 143, and the like.

The recording unit 182 records the time division multiplexed signal, which is inputted from the all data buffer 183, onto the DVD 199.

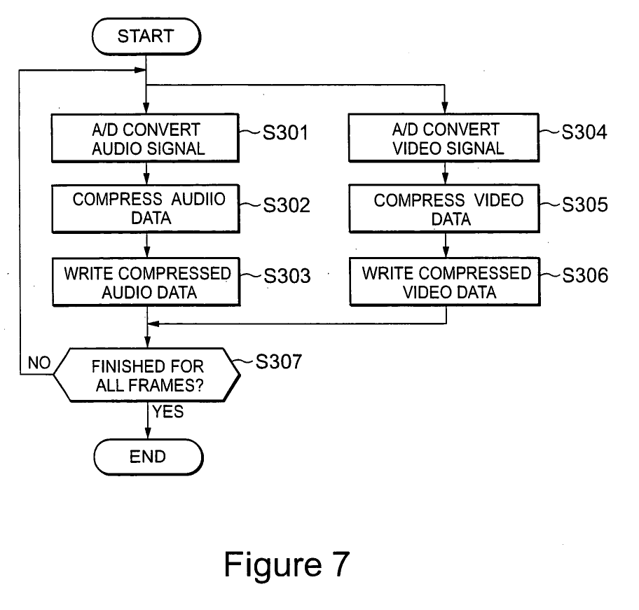

Next, an operation of a part of the sub-picture inserting apparatus according to the third embodiment will be described with reference to FIG. 7.

Steps S301 to S303 and steps S304 to S306 are performed in parallel with each other and continuously.

In step S301, the audio A/D converter 112 A/D-converts an audio signal to obtain audio data. In step S302, the audio data compression unit 111 compresses the audio data to obtain compressed audio data. In step S303, the audio data compression unit 111 writes the compressed audio data in the compressed audio data buffer 113.

In step S304, the video A/D converter 123 A/D-converts a video signal to obtain video data. In step S305, the video data compression unit 122 compresses the video data to obtain compressed video data. In step S306, the video data compression unit 122 writes the compressed video data in the compressed video data buffer 124.

The sub-picture inserting apparatus proceeds to step S307 from step S303 and step S306 and determines whether or not processing of steps S301 to S306 for all frames, which should be recorded onto the DVD 199, has been finished. If the processing has been finished, the sub-picture inserting apparatus ends the processing, and if the processing has not been finished, returns to steps S301 and S304.

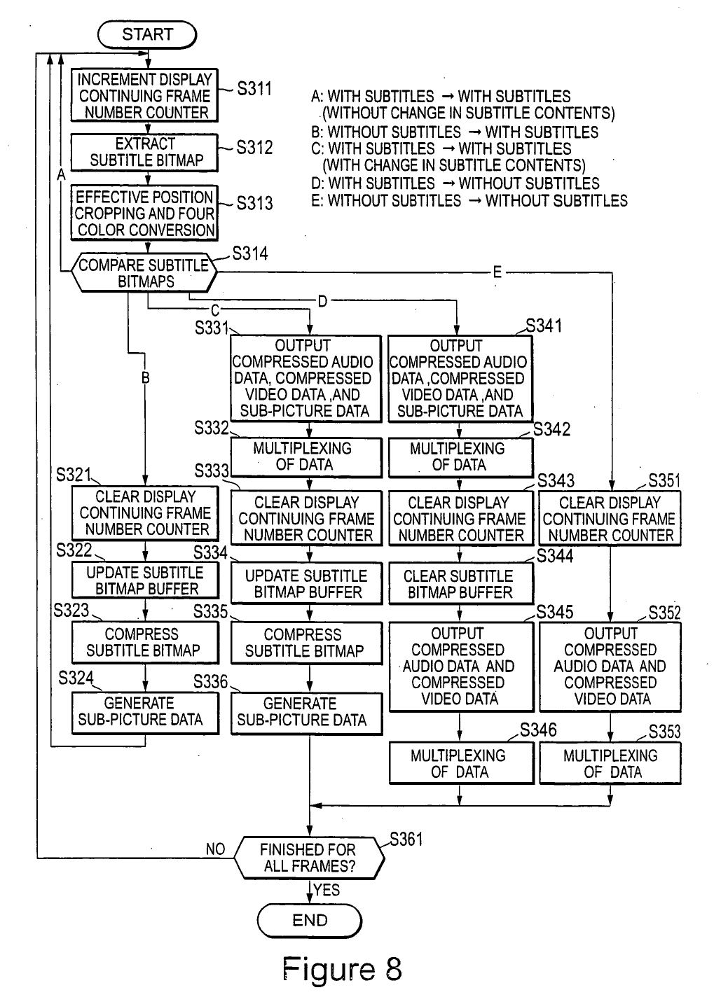

Next, an operation of other parts of the sub-picture inserting apparatus will be described with reference to FIG. 8.

First, the subtitle bitmap comparison unit l43 increments the display continuing frame number counter (step S311). Next, the subtitle bitmap extraction unit 141 extracts a subtitle bitmap (step S312). However, if there is no subtitle bitmap, the subtitle bitmap extraction unit 141 does not extract anything. Next, the effective position cropping and four-color conversion unit 142 crops an effective position of subtitles and subjects it to four-color conversion (step S313). However, if there is no subtitle bit map, there is no result of the cropping and the four-color conversion.

Next, the subtitle bitmap comparison unit 143 compares the subtitle bitmap inputted form the four-color conversion unit 142 and the subtitle bitmap stored in the subtitle bitmap buffer 144, and proceeds to any one of steps S311, S321, S331, S341, and S351 according to a result of the comparison.

What is indicated by “A” in FIG. 8 is a case in which a state of the subtitle bitmap buffer 144 shifts from “with subtitles” to “with subtitles” and there is no change in contents of the subtitles, that is, a case in which a subtitle bitmap is stored in the subtitle bitmap buffer 144 and a subtitle bit map identical with this is inputted from the effective position cropping and four-color conversion unit 142.

What is indicated by “B” in FIG. 8 is a case in which a state of the subtitle bitmap buffer 144 shifts from “without subtitles” to “with subtitles”, that is, a case in which no subtitle bit map is stored in the subtitle bitmap buffer 144 and a new subtitle bitmap is inputted from the effective position cropping and four-color conversion unit 142.

What is indicated by “C” in FIG. 8 is a case in which a state of the subtitle bitmap buffer 144 shifts from “with subtitles” to “with subtitles” and there is a change in contents of the subtitles, that is, a case in which a subtitle bitmap is stored in the subtitle bit map buffer 144, and a subtitle bitmap different from this is inputted from the effective position cropping and four-color conversion unit 142.

What is indicated by “D” in FIG. 8 is a case in which a state of the subtitle bitmap buffer 144 shifts from “with subtitles” to “without subtitles”, that is, a case in which a subtitle bitmap is stored in the subtitle bitmap buffer 144, and a subtitle bitmap is not inputted from the effective position cropping and four-color conversion unit 142′.

What is indicated by “E” in FIG. 8 is a case in which a state of the subtitle bitmap buffer 144 shifts from “without subtitles” to “without subtitles”, that is, a subtitle bitmap is not stored in the subtitle bitmap buffer 144, and a subtitle bitmap is not inputted from the effective position cropping and four-color conversion unit 142.

If a result of judgment in step S314 is “A”, the sub-picture inserting apparatus returns to step S311.

If a result of judgment in step S314 is “B”, the sub-picture inserting apparatus proceeds to step S321. In step S321, the sub-picture inserting apparatus clears the display continuing frame number counter 145. Next, the sub-picture inserting apparatus updates contents of the subtitle bitmap buffer 144 according to the subtitle bitmap inputted from the effective-position cropping and four-color conversion unit 142 (step S322). Next, the sub-picture generation unit 136 compresses a subtitle bitmap in the subtitle bitmap buffer 144 after update (step S323) and performs header addition or the like to generate sub-picture data (step S324). The sub-picture inserting apparatus holds the generated sub-picture data in the sub-picture data generation unit 136. The sub-picture inserting apparatus returns to step S311 from step S324.

If a result of judgment in step S314 is “C”, the sub-picture inserting apparatus proceeds to step S331. In step S331, the sub-picture inserting apparatus reads out compressed audio data accumulated during continuation of subtitles from the compressed audio data buffer 113, reads out compressed video data accumulated during continuation of subtitles from the compressed video data buffer 124, and supplies these data to the multiplexer 181 according to the control of the subtitle bitmap comparison unit 143. In addition, the sub-picture inserting apparatus supplies the sub-picture data held in the sub-picture data generation unit 136 to the multiplexer 181 according to the control of the subtitle bitmap comparison unit 143. Next, the multiplexer 181 subject the supplied data to time axis multiplexing (step S332). Next, the subtitle bitmap comparison unit 143 clears the display continuing frame number counter 145 (step S333). Next, the subtitle bitmap comparison unit 143 updates contents of the subtitle bitmap buffer 144 according to the subtitle bitmap inputted from the effective position cropping and four-color conversion unit 142 (step S334). Next, the sub-picture generation unit 136 compresses the subtitle bitmap after update in the subtitle bitmap buffer 144 (step S335) and performs header addition or the like to generate sub-picture data (step S336). The sub-picture inserting apparatus holds the generated sub-picture data in the sub-picture generation unit 136. The sub-picture inserting apparatus proceeds to step S361 from step S336.

If a result of judgment in step S314 is “D”, the sub-picture inserting apparatus proceeds to step S341. In step S341, the sub-picture inserting apparatus reads out compressed audio data accumulated during continuation of subtitles from the compressed audio data buffer 113, reads out compressed video data accumulated during continuation of subtitles from the compressed video data buffer 124, and supplies these data to the multiplexer 181 according to the control of the subtitle bitmap comparison unit 143. In addition, in step S341, the sub-picture inserting apparatus also supplies the sub-picture data held in the sub-picture generation unit 136 to the multiplexer 181 according to the control of the subtitle bitmap comparison unit 143. Next, the multiplexer 181 subjects the supplied data to time axis multiplexing (step S342). Next, the subtitle bitmap comparison unit 143 clears the display continuing frame number counter 145 (step S343) and also clears the subtitle bitmap buffer 144 (step S344). Next, the sub-picture inserting apparatus reads out compressed audio data of a present frame from the compressed audio data buffer 113, reads out compressed video data of the present frame from the compressed video data buffer 124, and supplies these data to the multiplexer 181 according to the control of the subtitle bitmap comparison unit 143 (step S345). The sub-picture inserting apparatus does not supply sub-picture data to the multiplexer 181. Next, the multiplexer 181 subjects the supplied data to time axis multiplexing (step S346); The sub-picture inserting apparatus proceeds to step S361 from step S346.

If a result of judgment in step S314 is “E”, the sub-picture inserting apparatus proceeds to step S351. In step S351, the subtitle bitmap comparison unit 143 clears the display continuing frame number counter 145. Next, the sub-picture inserting apparatus reads out compressed audio data of a present frame from the compressed audio data buffer 113, reads out compressed audio data of the present frame from the compressed video data buffer 124, and supplies these data to the multiplexer 181 according to the control of the subtitle bitmap comparison unit 143 (step S352). The sub-picture inserting apparatus does not supply sub-picture data to the multiplexer 181. Next, the multiplexer 181 subject the supplied data to time axis multiplexing (step S353). The sub-picture inserting apparatus proceeds to step S361 from step S353.

Instep S361, the sub-picture inserting apparatus judges whether or not processing of all frames, which should be recorded onto the DVD 199, has been finished. If the processing has been finished, the sub-picture inserting apparatus ends the processing, otherwise, returns to step S311 to start processing of the next frame.

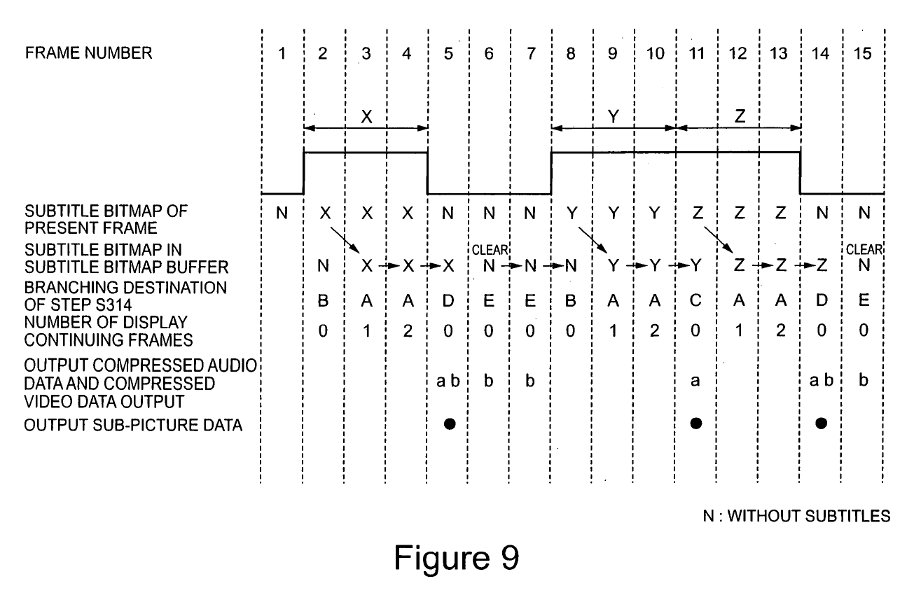

Next, an example of an operation of the sub-picture inserting apparatus according to the third embodiment will be described with reference to FIG. 9.

In the example of FIG. 9, there are subtitles X in second to fourth frames, there are subtitles Y in eighth to tenth frames, and there are subtitles Z in eleventh to thirteenth frames. In other frames, there are no subtitles.

A subtitle bitmap of a present frame (a subtitle bitmap to be supplied to the subtitle bitmap comparison unit 143 from the effective position cropping and four-color conversion unit 142) and a subtitle bitmap of a preceding frame (a subtitle bit map in the subtitle bitmap buffer 144) are as shown in FIG. 9. From a relation between both the subtitle bitmaps, branching destinations of step S314 are as shown in FIG. 9. In accordance with this, the number of display continuing frames of the display continuing frame number counter 145 changes as shown in FIG. 9. In addition, in accordance with the branching destinations of FIG. 9, compressed audio data and compressed video data are supplied to the multiplexer 181 from the respective buffers 113, 124 as shown in FIG. 9. “a” indicates that data of one or more frames, which is accumulated in the buffers 113, 124 during continuation of subtitles, to the multiplexer 181, and “b” indicates that data of the present frame is supplied to the multiplexer 181. More specifically, in the fifth frame, data of the second to fourth frames is supplied to the multiplexer 181 in step S341, and data of the sixth frame is supplied to the multiplexer 181 in step S345; in the sixth frame, data of the sixth frame is supplied to the multiplexer 181 in step S352; in the seventh frame, data of the seventh frame is supplied to the multiplexer 181 in step S352; in the eleventh frame, data of the eighth to tenth frames is supplied to the multiplexer 181 in step S331; in the fourteenth frame, data of the eleventh to thirteenth frames is supplied to the multiplexer 181 in step S341, and data of the fourteenth frame is supplied to the multiplexer 181 in step S345; and in the fifteenth frame, data of the fifteenth frame is supplied to the multiplexer 181 in step. S352.

A fourth embodiment of the present invention will be described below.

In the third embodiment, the sub-picture inserting apparatus inputs subtitles from the television tuner 150 in the form of a bitmap. However, in a fourth embodiment, a sub-picture inserting apparatus inputs subtitles from the television tuner 150 in the form of a character code.

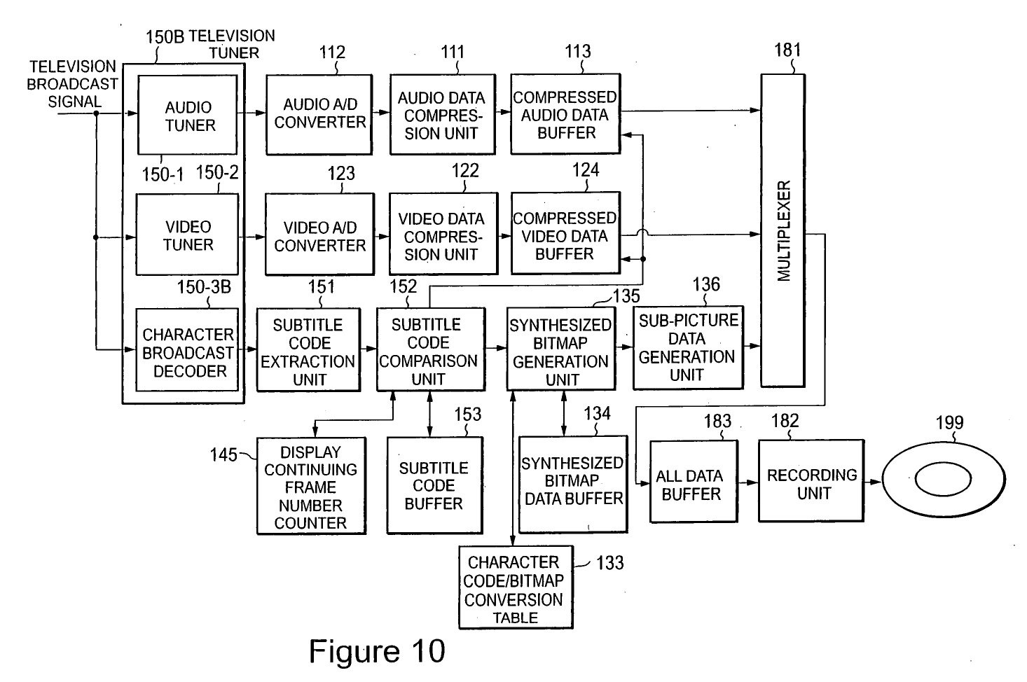

FIG. 10 is block diagram showing a structure of the sub-picture inserting apparatus according to the fourth embodiment and the periphery thereof. As it is evident when FIGS. 6 and 10 are compared, the sub-picture inserting apparatus according to the fourth embodiment is different from the sub-picture inserting apparatus according to the third embodiment only in parts relating to sub-picture generation. In addition, the character broadcast decoder 150-3 for outputting a bitmap of subtitles is replaced with a character broadcast decoder 150-3B for outputting a character code of subtitles. Accordingly, the television tuner 150 is replaced with a television tuner 150B.

A subtitle code extraction unit 151 replaces the subtitle bitmap extraction unit 141, and extracts a character code of subtitles. A subtitle code comparison unit 152 replaces the subtitle bitmap comparison unit 143, and performs the same processing as in the subtitle bitmap comparison unit 143 on the basis of a subtitle character code instead of a subtitle bitmap. A display continuing frame number counter 145 is the same as that of the third embodiment. A subtitle code buffer 153 replaces the subtitle bitmap buffer 144, and stores a subtitle character code. A synthesized bitmap generation unit 135 is the same as the synthesized bitmap generation unit 135 in the first embodiment, and uses a character code/bitmap conversion table 133 and a synthesized bitmap data buffer 134 to generate a synthesized bitmap of subtitles. A character code/bitmap conversion table 133 and a synthesized bitmap data buffer 134 are the same as those in the first embodiment. A sub-picture data generation unit 136 is the same as that in the first embodiment.

A part of the sub-picture inserting apparatus of the fourth embodiment performs an operation shown in FIG. 7 as in the third embodiment.

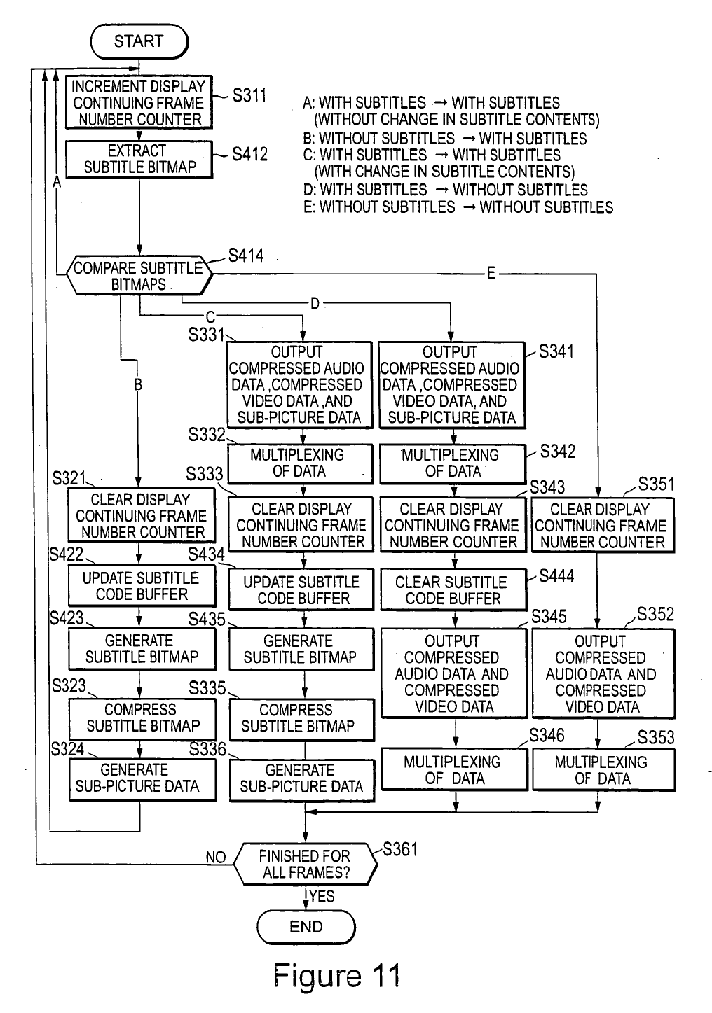

FIG. 11 shows an operation of the other parts of the sub-picture inserting apparatus according to the fourth embodiment. Only those points in which the operation of the other parts of the sub-picture inserting apparatus according to the fourth embodiment is different from that of the sub-picture inserting apparatus according to the third embodiment will be described with reference to FIGS. 8 and 11.

The extraction of a subtitle bitmap by the subtitle bitmap extraction unit 141 (step S312) is replaced with extraction of a character code of subtitles by the subtitle code extraction unit 151 (step S412). The effective position cropping and four-color conversion by the effective position cropping and four-color conversion unit 142 (step S313) is not performed. The subtitle bitmap comparison by the subtitle bitmap comparison unit 143 (step S314) is replaced with comparison of a character code of subtitles by the subtitle code comparison unit 152 (step S414).

The update of the subtitle bitmap buffer 144 by the subtitle bitmap comparison unit 143 (step S322) is replaced with update of the subtitle code buffer 153 by the subtitle code comparison unit 152 (step S422). Subtitle bitmap generation by the synthesized bitmap generation unit 135 (step S423) is inserted between steps S422 and S323. In step S423, steps 214 to S217 (FIG. 2) are performed.

The update of the subtitle bitmap buffer 144 by the subtitle bitmap comparison unit 143 (step S334) is replaced with update of the subtitle code buffer 153 by the subtitle code comparison unit 152 (step S434). Subtitle bitmap generation by the synthesizing bitmap generation unit 135 (step S435) is inserted between steps S434 and S335. In step S435, steps S214 to s217 (FIG. 2) are performed.

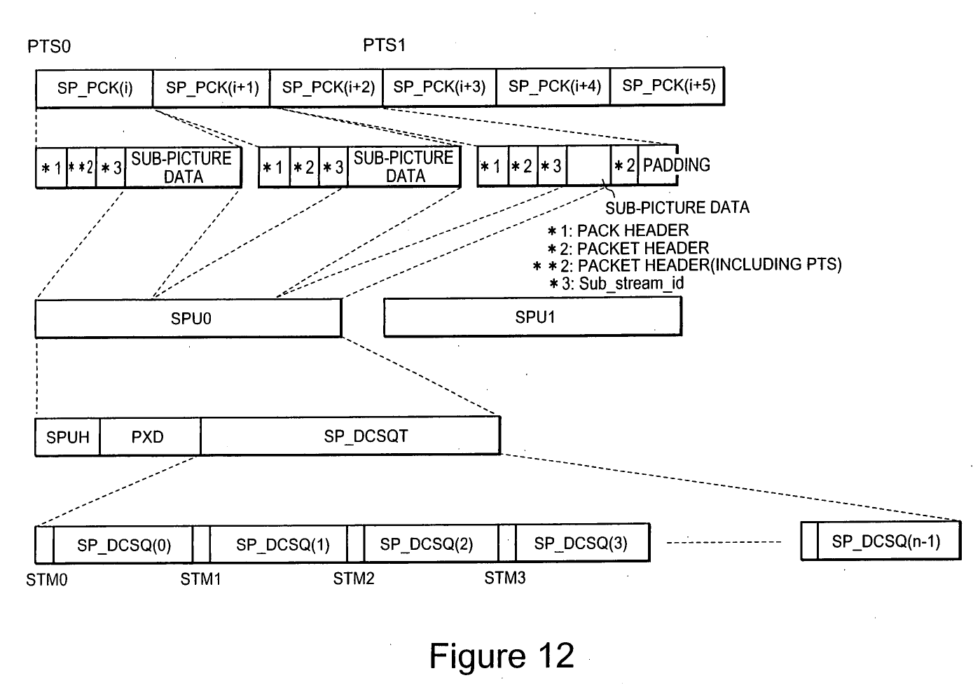

Next, a structure of sub-picture data will be described with reference to FIG. 12.

The sub-picture data is constituted by a basic unit called a sub-picture unit (SPU). The sub-picture unit has a variable length and is included extending over plural packs. In an example of FIG. 12, a sub-picture unit SPU0 occupies all of two packs and a part of one pack. What is indicated by PTS in FIG. 12 is a presentation time stamp, which represents a time for processing a first command in a command table (SP_DCSQT).

The sub-picture unit is constituted by a header (SPUH), pixel data (PXD) subjected to run-length compression and the command table (SP_DCSQT). The pixel data consists of two bits per one pixel before it is compressed. As described above, two bits indicate which one of a background pixel, a pattern pixel, a highlighted pixel 1, and a highlighted pixel 2 each pixel is. A color of a pixel of each type is determined by a color code and a contrast.

The command table (SP_DCSQT) is divided into plural sections, and each section is constituted by a command and time information STM for executing the command. There are nine types of commands as shown in the table below, and the time information STM is represented by an offset value from the PTS.

TABLE 1

| Command | |
|---|---|
| Name | Contents |
| FSTA_DST | Forcedly set display start timing of pixel data |
| STA_DSP | Set display start timing of pixel data |
| STP_DSP | Set display stop timing of pixel data |
| SET_COLOR | Set color code of pixel data |
| SET_CONTR | Set contrast between pixel data and main picture |
| SET_DAREA | Set display area of pixel data |
| SET_DSPXA | Set display start address of pixel data |
| CHG_COLCON | Set change of color and contrast for pixel data |
| CMD_END | End of display control command |

In order to designate the number of display continuing frames of subtitles of the third and fourth embodiments, it is sufficient to represent a time equivalent to the number of frames with time information STM and use STP_DSP of sub-picture OFF as a command. In this way, when the time represented by the time information STM has elapsed since display of a sub-picture of subtitles is started, the display of the sub-picture ends.

As described above, according to the present invention, it becomes possible to automatically generate additional information for adding additional information to an audio video signal, which should be recorded or transmitted, on the basis of original additional information inserted in an original audio video signal, and insert the automatically generated additional information to the audio video signal which should be recorded or transmitted. Therefore, it becomes possible to add the additional information, which is added to the original audio video signal, to the audio video signal, which should be recorded or transmitted, without spoiling it.

In particular, since date and time and subtitles changing every moment, which a user practically cannot input manually, can be handled, the present invention is convenient for the user.

What is claimed is:

1. An additional information inserting apparatus comprising:
means for extracting original additional information that has been inserted in an original audio video signal;
means for generating secondary additional information based on the original additional information; and
means for adding the secondary additional information to a secondary audio video signal, the secondary audio video signal being based on the original audio video signal.

2. The additional information inserting apparatus as claimed in claim 1,
wherein said original additional information is original date and time information, and
wherein said secondary additional information is secondary date and time information.

3. The additional information inserting apparatus as claimed in claim 2,
wherein said secondary date and time information comprises data in plural formats.

4. The additional information inserting apparatus as claimed in claim 1,
wherein said original additional information is original subtitle information, and
wherein said secondary additional information is secondary subtitle information.

5. A sub-picture inserting apparatus comprising:
a demultiplexer that receive's as an input a time division multiplexed signal of audio data, compressed video data, and sub-code data, the demultiplexer being constructed to produce as outputs the audio data, the compressed video data, and the sub-code data based on the time division multiplexed signal;
an audio data compression unit that receives as an input the audio data and generates as an output compressed audio data;
a video data expansion unit that expands the compressed video data in accordance with a DV system and outputs restored video data;
a video data compression unit that compresses the restored video data and outputs re-compressed video data;
a date and time data buffer which stores date and time data;
a date and time data comparison unit which extracts date and time data in the sub-code data, compares the extracted date and time data with date and time data stored in the date and time data buffer and updates contents of the date and time data buffer when necessary to reflect changes in the date and time data extracted from the sub-code data;
a character code/bitmap conversion table which stores a bitmap of images of characters corresponding to respective character codes;
a synthesized bitmap data generation unit which retrieves a bitmap of each character of the date and time data, which is inputted from the date and time data comparison unit, from the character code/bitmap conversion table, and synthesizes a bitmap of all the characters of the date and time data to generate synthesized bitmap data;
a synthesized bitmap data buffer which stores the synthesized bitmap data;
a sub-picture generation unit which compresses the synthesized bitmap data according to run-length coding and adds a predetermined header to the synthesized bitmap data to generate sub-picture data;
a multiplexer which multiplexes the compressed audio data, the re-compressed video data, and the sub-picture data in a time division manner and outputs a time division multiplexed signal; and
a recording unit which records the time division multiplexing signal.

6. A sub-picture inserting apparatus as claimed in claim 5,
wherein said date and time data buffer stores the date and time data in plural formats for respective sub-pictures;
wherein said synthesized bitmap data buffer stores plural kinds of synthesized bitmap data for respective sub-pictures.

7. A sub-picture inserting apparatus comprising:
an audio A/D converter which A/D-converts an analog audio signal outputted by an audio tuner of a television tuner and outputs audio data;
an audio data compression unit which compresses the audio data and outputs compressed audio data;
a compressed audio data buffer which delays the compressed audio data in variable time;
a video A/D converter which converts an analog video signal outputted by the audio tuner of the television tuner and outputs video data;
a video data compression unit which compresses the video data and outputs compressed video data;
a compressed video data buffer which delays the compressed video data in variable time;
a subtitle bitmap extraction unit which extracts subtitle bitmap data, which is outputted by a character broadcast decoder of the television tuner, and outputs the subtitle bitmap data;
an effective position cropping and four-color conversion unit which crops only an effective part from the subtitle bitmap data, converts the effective part into bitmap data of no more than four colors to be used in a sub-picture and outputs the cropped and converted the subtitle bitmap data;
a subtitle bitmap buffer which stores the subtitle bitmap data;
a subtitle bitmap comparison unit which compares the subtitle bitmap data inputted the four-color conversion unit and the subtitle bit map stores in the subtitle bitmap buffer and proceeds according to a result of the comparison;
a display continuing frame number counter which counts a number of frames in which display of each subtitle is continuing;
a sub-picture generation unit which compresses the subtitle bitmap data according to run-length coding and adds a predetermined header to the subtitle bitmap to generate sub-picture data and output the sub-picture data;
a multiplexer which multiplexes the compressed audio data, the compressed video data, and the sub-picture data in a time division manner and outputs a time division multiplexed signal; and
a recording unit which records the time division multiplexed signal.

8. A sub-picture inserting apparatus comprising:
an audio A/D converter which A/D-converts an analog audio signal outputted by an audio tuner of a television tuner and outputs audio data;
an audio data compression unit which compresses the audio data according to a method specified in a DVD system and outputs compressed audio data;
a compressed audio data buffer which delays compressed audio data in variable time;
a video A/D converter which converts an analog video signal outputted by the audio tuner of the television tuner and outputs video data;
a video data compression unit which compresses the video data according to a method specified in the DVD system and outputs compressed video data;
a compressed video data buffer which delays the compressed video data in variable time;
a subtitle code extraction unit which extracts character codes of subtitle, which is outputted by a character broadcast decoder of the television tuner, and outputs the character codes of subtitle;
a subtitle code buffer which stores the character codes of subtitle;
a subtitle code comparison unit which compares the character codes of subtitle inputted from the subtitle code extraction unit with the character codes of subtitle stored in the subtitle code buffer and proceeds according to a result of the comparison;
a display continuing frame number counter which counts the number of frames in which display of each subtitle is continuing;
a character code/bitmap conversion table which stores a bitmap of images of characters corresponding to respective character codes;
a synthesized bitmap data generation unit which retrieves a bitmap of each character codes of subtitle, which is inputted from the subtitle code comparison unit, from the character code/bitmap conversion table, and synthesizes a bitmap of all the characters of the subtitle to generate synthesized bitmap data;
a synthesized bitmap data buffer which stores the synthesized bitmap data;
a sub-picture generation unit which compresses the synthesized bitmap data according to run-length coding and adds a predetermined header to the synthesized bitmap data to generate sub-picture date and output the sub-picture date;
a multiplexer which multiplexes the compressed audio data, the compressed video data, and the sub-picture data in the time division manner and outputs a time division multiplexing signal; and
a recording unit which records the time division multiplexing signal.

9. An additional information inserting method comprising the steps of:
extracting original additional information that has been inserted in an original audio video signal;
generating secondary additional information based on the original additional information; and
adding the secondary additional information to a secondary audio video signal, the secondary audio video signal being based on the original audio video signal.

10. The additional information inserting method as claimed in claim 9,
wherein said original additional information is original date and time information, and
wherein said secondary additional information is secondary date and time information.

11. The additional information inserting method as claimed in claim 10,
wherein said secondary date and time information comprises data in plural formats.

12. The additional information inserting method as claimed in claim 9,
wherein said original additional information is original subtitle information, and
wherein said secondary additional information is secondary subtitle information.

13. The sub-picture inserting apparatus as claimed in claim 5, wherein the time division multiplexed signal received as an input by the demultiplexer is provided by a digital video tape player.

14. The sub-picture inserting apparatus as claimed in claim 13, wherein the audio data compression unit is constructed to perform the audio compression using a method that complies with a DVD standard;
the video data expansion unit is constructed to perform the video data expansion using a method that complies with a DV standard; and
the video data compression unit is constructed to perform the video data compression using a method that complies with a DVD standard.

15. The sub-picture inserting apparatus as claimed in claim 7, wherein the audio data compression unit is constructed to perform the audio compression using a method that complies with a DVD standard; and
the video data compression unit is constructed to perform the video data compression using a method that complies with a DVD standard.

16. A sub-picture inserting apparatus comprising:
a demultiplexer that receives as an input a time division multiplexed signal of audio data, compressed video data, and sub-code data, the demultiplexer being constructed to produce as outputs the audio data, the compressed video data, and the sub-code data based on the time division multiplexed signal;
a date and time data comparison unit which extracts date and time data from the sub-code data and converts the date and time data into one of milliseconds, seconds, and minutes;
a date and time data buffer which stores the converted date and time data;
a character code/bitmap conversion table which stores a bitmap of images of characters corresponding to respective character codes;
a synthesized bitmap data generation unit which receives as an input the converted date and time data from the date and time data comparison unit and retrieves a bitmap of each character of the converted date and time data from the character code/bitmap conversion table, and synthesizes a bitmap of all the characters of the converted date and time data to generate synthesized bitmap data;
a synthesized bitmap data buffer which stores the synthesized bitmap data;
a sub-picture generation unit which compresses the synthesized bitmap data according to run-length coding and adds a predetermined header to the synthesized bitmap data to generate sub-picture data; and
a multiplexer which multiplexes an audio signal based on the audio data, a video signal based on the compressed video data, and the sub-picture data in a time division manner and outputs a reconstructed time division multiplexed signal;
wherein date and time data comparison unit compares the extracted date and time data with the converted date and time data stored in the date and time data buffer and updates contents of the date and time data buffer when necessary to reflect changes in the date and time data from the sub-code data.
